(19) United States
(12) Patent Application Publication
(10) Pub. No.: US 2026/0237004 A1
(43) Pub. Date: Aug. 13, 2026

(54) GEOTHERMAL DATA FOUNDATION

(71) Applicant: Schlumberger Technology Corporation, Sugar Land, TX (US)

(72) Inventors: Sushant SHEKHAR, Pune (IN); Gayatri Farma Novenita, Pune (IN); Sayani Kumar, Pune (IN)

(21) Appl. No.: 19/156,412

(22) PCT Filed: Feb. 16, 2024
(86) PCT No.: PCT/US2024/016166

§ 371 Date: Aug. 14, 2025

Related U.S. Application Data
(60) Provisional application No. 63/485,649, filed on Feb. 17, 2023.

(51) Int. Cl. G06Q 50/06; G06Q 30/0202

(52) U.S. Cl. CPC G06Q 50/06; G06Q 30/02024

(57) ABSTRACT

Computing systems, computer-readable media, and methods for providing an integrated platform. The method includes obtaining data from at least one source, wherein the data is in multiple formats and is related to one of an energy exploration stage, an energy development stage, and an operations stage. At least one data item from the at least one source is specified for visulization. The data is processed, wherein the processing includes parsing, extracting, and ingesting the data, the data including the at least one specified data item. Mahine learning is leveraged to obtain an optimum forecasting model, the leveraging including using at least one of autoregressive integrated moving average modelling and temporal fusion transformers. The specified at least one data item is visualized. A forecasting summary is provided based on theoptimum forecasting model.

### CROSS REFERENCE TO RELATED APPLICATIONS

This application claims the benefit of and priority to U.S. Provisional Patent Application No. 63/485,649 filed on Feb. 17, 2023, which is hereby incorporated by reference in its entirety.

### BACKGROUND

A typical life cycle of a geothermal system includes an exploration stage, followed by a development stage, and finally an operations stage in which actual production and monitoring takes place.

Each stage of a geothermal system has associated risks and costs. During initial stages of exploration, many projects are canceled due to uncertainty and economic factors. Due to the risks and costs, much data and information is needed in order to understand a subsurface geothermal system so that the geothermal project can be successfully executed. However, current geothermal research and operational data are stored in silos and are available in various formats from multiple vendors. Thus, analyzing data end to end is always challenging.

A geothermal system is very dynamic, and information always needs to be updated. Any slight changes can affect future decision making. As an example, if micro-seismic activity is detected during operations, reactivation of fractures can be triggered, which may lead to water circulation loss, which also can affect decision making concerning actions to be taken regarding the geothermal system.

Report creation at each of the stages is labor intensive and requires a massive amount of time. This process is not reusable and must be performed over again for each geothermal client. Additionally, available forecasting is limited to simulation forecasting from numerical engines.

Presently, there is no system or platform in place that could provide help with decision making regarding geothermal systems. As a result, resources are strained and costs associated with geothermal systems tend to be high. A platform that covers all stages from exploration to daily operations of a power plant by monitoring operations and providing real-time alerts and notifications could provide decision making help.

### SUMMARY

Embodiments of the present disclosure may provide a method for providing an integrated platform for a geothermal system. In an embodiment, the method may include obtaining data from at least one source, wherein the data is in multiple formats and is related to one of an energy exploration stage, an energy development stage, and an operations stage. At least one data item is specified from the at least one source for visualization. The data is processed, wherein the processing includes parsing, extracting, and ingesting the data, the data including the specified at least one data item. Machine learning is leveraged to obtain an optimum forecasting model, wherein the leveraging includes using at least one of autoregressive integrated moving average modelling and temporal fusion transformers. The specified at least one data item is visualized. A forecasting summary is provided based on the optimum forecasting model.

Embodiments of the present disclosure may also provide a computing system. The system includes a processor, a memory, and a bus connecting the processor with the memory, wherein the memory includes instructions for the processor to perform operations. The operations include obtaining data from at least one source, wherein the data is in multiple formats and is related to one of an energy exploration stage, energy development stage, and an operation stage. At least one data item from the at least one source is specified for visualization. The data is processed, wherein the processing includes parsing, extracting, and ingesting the data, and the data includes the specified at least one data item. Machine learning is leveraged to obtain an optimum forecasting model, wherein the leveraging includes using at least one of autoregressive integrated moving average modelling and temporal fusion transformers. The specified at least one data item is visualized such that a display screen is produced that is substantially similar to a display screen produced by a different product.

Embodiments of the present disclosure may also provide a non-transitory computer-readable medium that has instructions stored thereon for a processor of an integrated platform, such that when the processor executes the instructions, multiple operations are performed. According to the operations, data from at least one source is obtained, wherein the data is in multiple formats and is related to one of an energy exploration stage, and energy development stage, and an operations stage. At least one data item from the at least one source is specified for visualization. The data is processed, wherein the processing includes parsing, extracting, and ingesting the data, the data including the specified at least one data item. A macro is added to the integrated platform by copying the macro from a second source. Machine learning is leveraged to obtain an optimum forecasting model, wherein the leveraging includes using at least one of autoregressive integrated moving average modelling and temporal fusion transformers. The specified at least one data item is visualized, wherein the visualizing provides an analytics dashboard having sub-dashboards for each of multiple stages of a lifecycle of a geothermal system. A determination is made regarding whether the data includes an anomaly and a real-time alert is provided when the data is determined to include the anomaly. A forecasting summary is provided based on the optimum forecasting model. The visualization produces a display screen that is substantially similar to a display screen produced by a different product.

Thus, the computing systems and methods disclosed herein are more effective methods for processing collected data that may, for example, correspond to a surface and a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates an example solution architecture, according to an embodiment.

FIG. 5 illustrates a flowchart of a method for accessing and processing data according to at least one configurable template, detecting and reporting anomalies, and visualizing the processed data as specified by the at least one configurable template, according to an embodiment.

FIG. 6 illustrates an example appraisal summary display screen showing a geochemical distribution, Saphir modeling parameters from injection test wells, injection rate in liters per second for injection test wells, an analytical model of each injection test well, a comparison of a measured pressure trend and a simulated pressure trend, and an example of well water quality, according to an embodiment.

FIG. 7 shows an example exploration summary display screen that includes concise summarized information about geothermal fields on a regional scale, according to embodiments.

FIG. 8 shows an example development summary display screen having information regarding a fracture model of the area, pressure-temperature models, and different 3D models used in a development phase, according to embodiments.

FIG. 9 illustrates an example production performance summary display screen according to embodiments.

FIG. 10 illustrates an example injector performance summary display screen that may display performance of each well over a period of time as a factor of a water injection rate, injection pressure, and temperature, according to embodiments.

FIG. 11 shows an example facility planning and performance summary display screen having a facility performance section and a facility economics section, according to embodiments.

FIG. 12 shows a monitoring summary display screen according to embodiments. The monitor summary display screen may provide an overview of how a reservoir and a geothermal system change over time by leveraging trend plots and heat maps.

FIG. 13 shows an example email message that may be produced upon detecting an anomaly, according to an embodiment.

FIG. 14 shows an example magneto-telluric (MT) Forecast Summary display screen according to embodiments. The MT Forecast Summary display screen may include sunspot number forecasting, geomagnetic index forecasting, and solar radio flux forecasting, each of which may leverage machine learning to obtain an optimum forecasting model.

FIG. 15 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

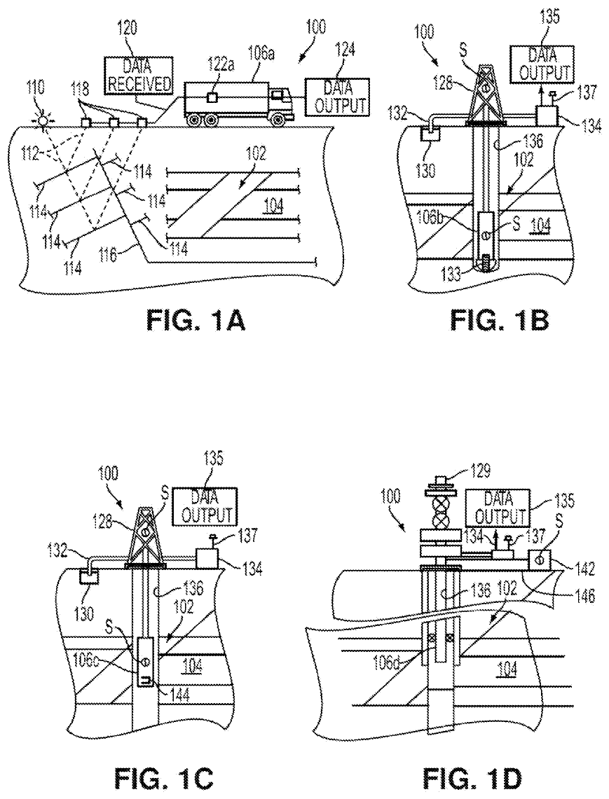

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors(S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

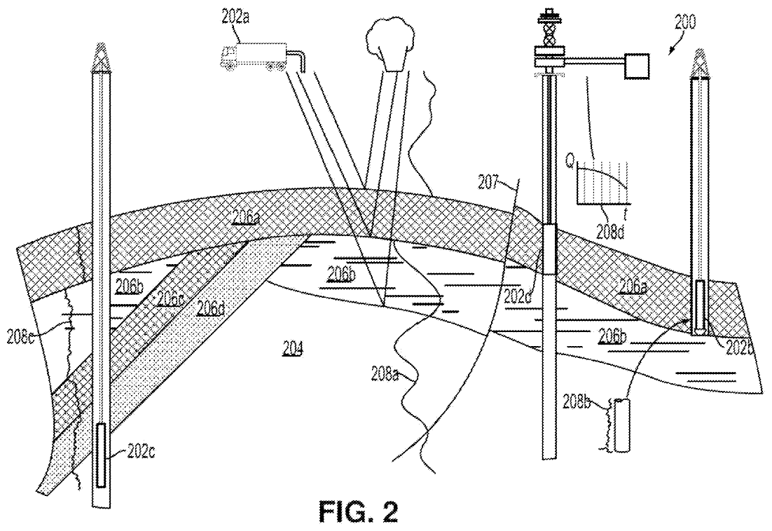

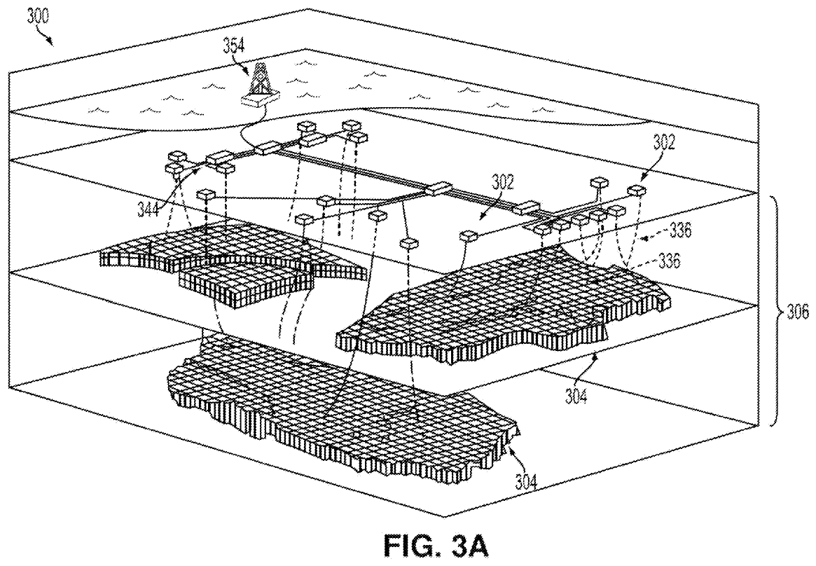

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analy zed using modeling techniques.

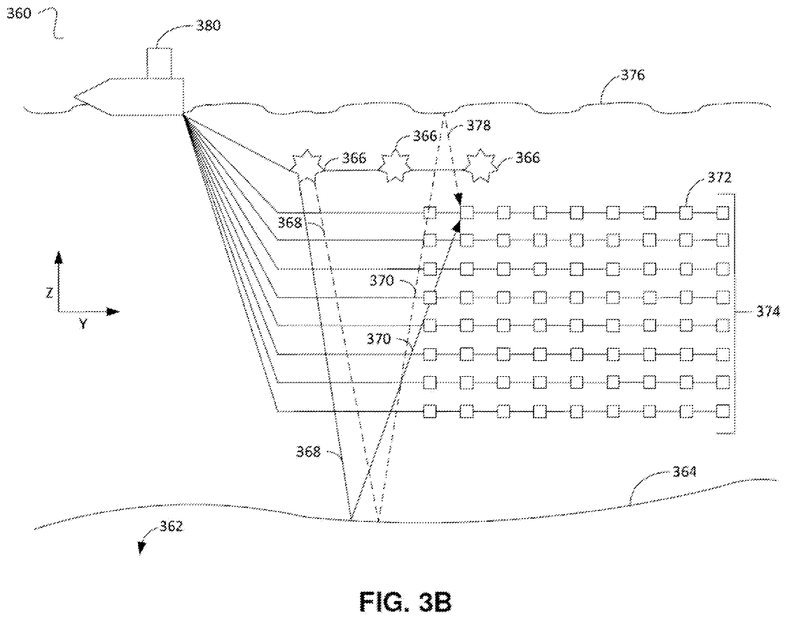

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

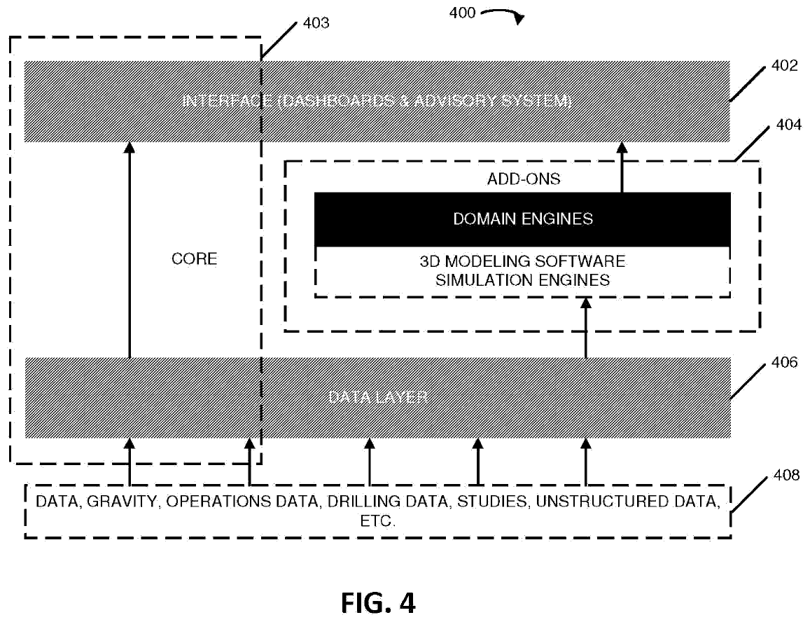

FIG. 4 illustrates an example architecture 400 of an integrated platform consistent with various embodiments described herein. The integrated platform may be a planning and monitoring system that provides real-time alerts and notifications covering all stages from exploration to daily operations of a power plant. Enhanced information visibility is fully customizable and can be integrated with products that include, but are not limited to DELFI and OSDU. DELFI is available from SLB of Houston, TX. OSDU is an open source data platform. Both DELFI and OSDU are offered as web applications or provided as an extended plugin in a product that includes, but is not limited to, SLB's legacy product Petrel. Architecture 400 may include a user interface 402 that may further include dashboards and an advisory system. Add-ons 404 may include domain engines and 3D modeling software simulation engines, which may further include geologic modelling and simulation engines in some embodiments. The domain engines may include, but are not limited to, DELFI. 3D modeling software simulation engines may include, but are not limited to, Eclipse and Petrel, both of which are available from SLB of Houston, TX. A data layer 406 may include a database, which may further include, but is not limited to, a MongoDB database, which is a NoSQL database. Data 408 that may be included in data layer 406 may be energy-related data, gravity-related data, operations data, drilling data, data related to studies, unstructured data, structured data, etc. The data may be included in multiple types of files including, but not limited to, a word processing file, a text file, an image file, and a portable document file.

The advisory system includes an alerts and notification system. A set of threshold rules have been defined for different parameters including, but not limited to, brine temperature, injection pressure, subsurface pressure, etc. in ingestion pipelines. If a data point is observed that crosses a threshold rule during ingestion, an automated alert may be sent to respective authorities. In some embodiments, the automated alert may be sent as an email notification. A notification may be triggered by a user from the dashboard interface as well by a user clicking on or selecting a “send notification” button, if the user finds any anomalous data during data analysis.

In an embodiment including a web-based application, a . NET core webapp may be provided with a backend written in C # and a MongoDB database. At regular intervals, parsers may parse and extract data from different types of files including, but not limited to, spreadsheets, word processed files, and portable document format (PDF) files. The data may be ingested into the MongoDB database for each category of geothermal data such as, for example, exploration stage data, energy development stage data, and operations stage data. Data files may be ingested from a local repository, but can easily be implemented on an interface as well as in a “drop-box” template, where users can drag and drop files or upload files manually for ingestion.

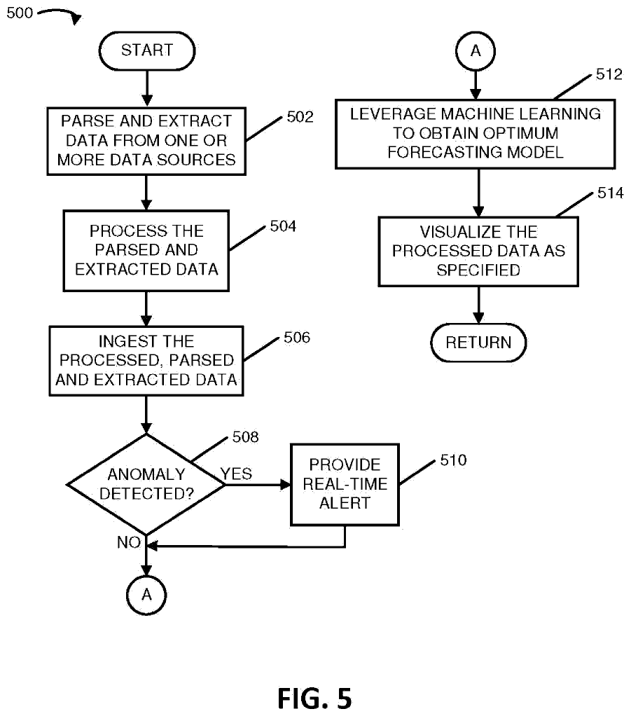

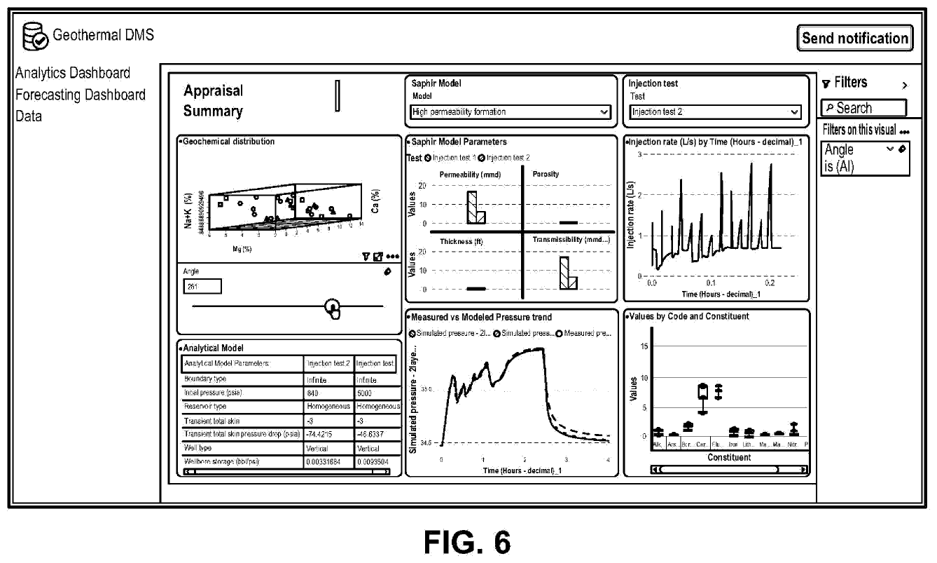

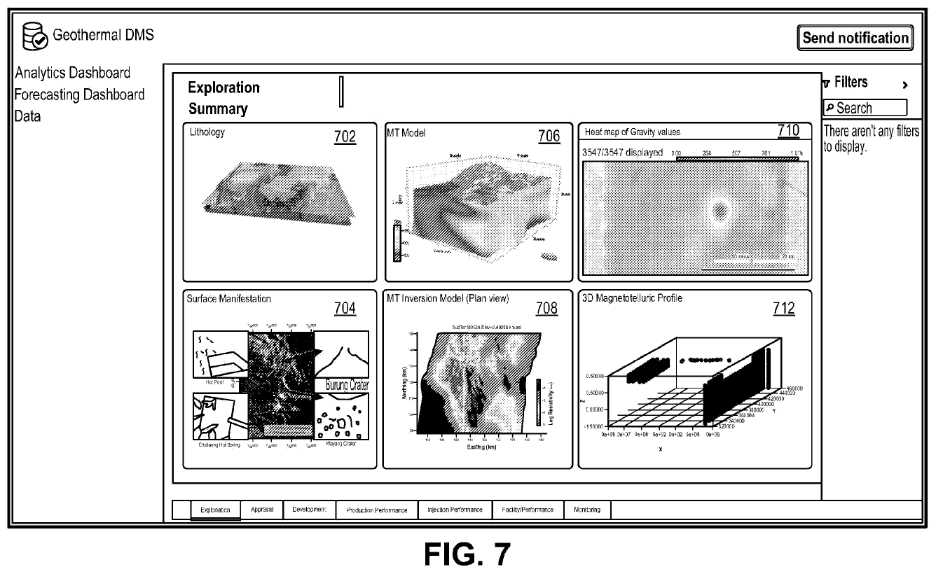

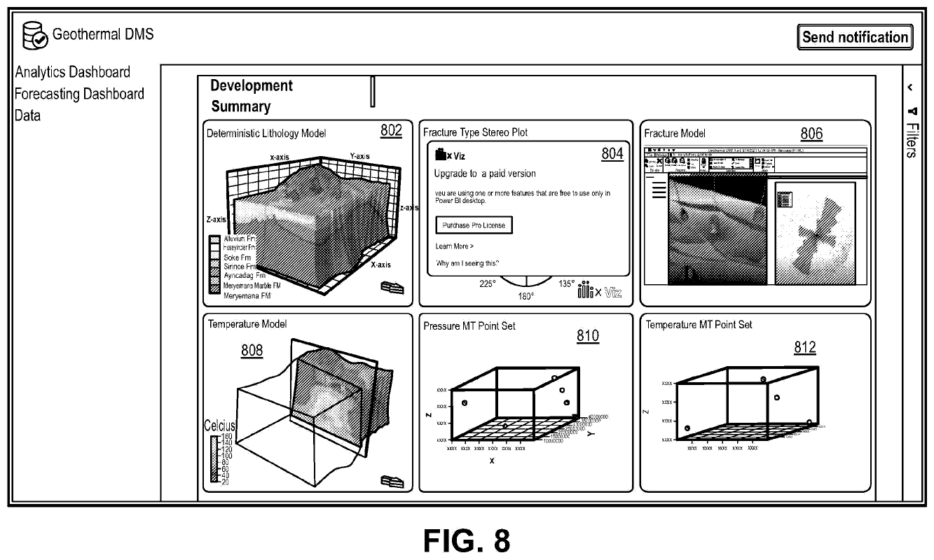

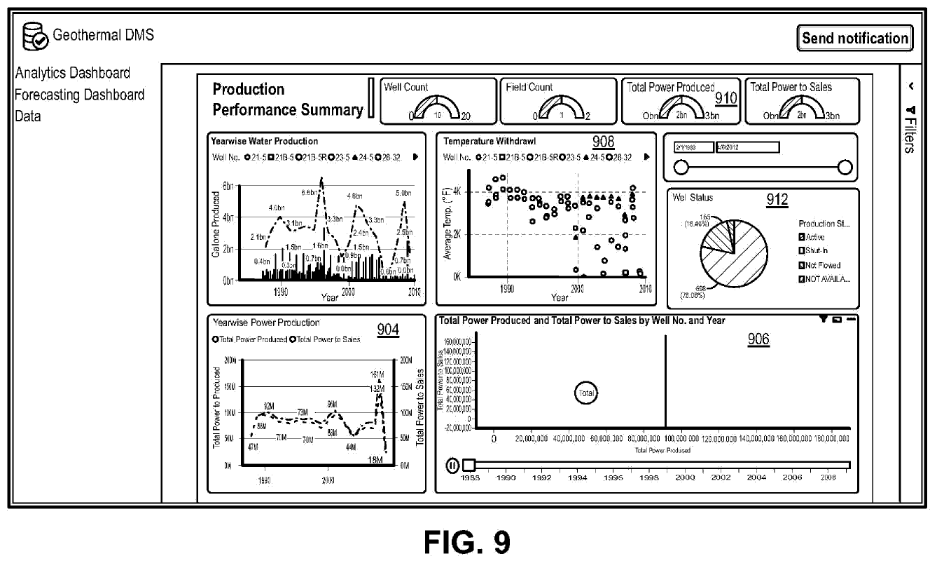

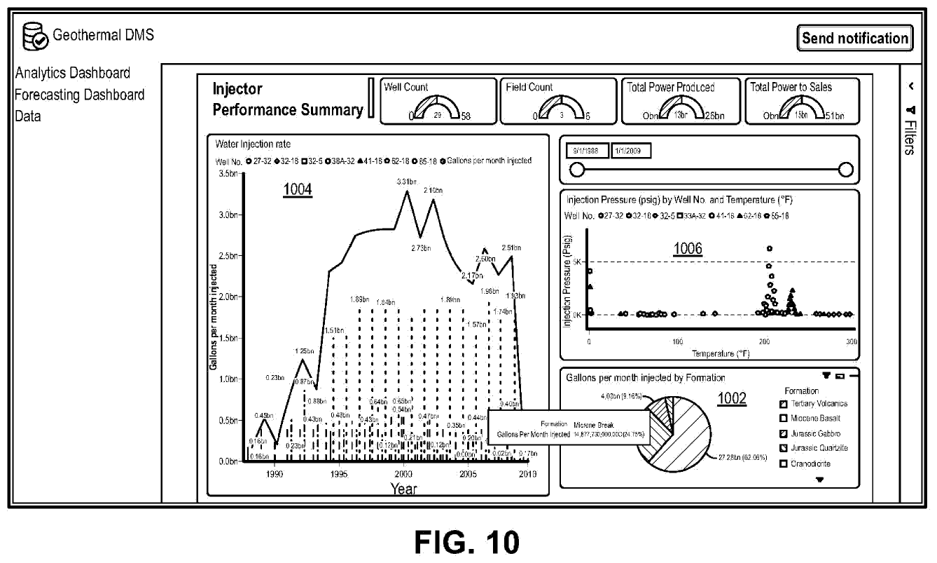

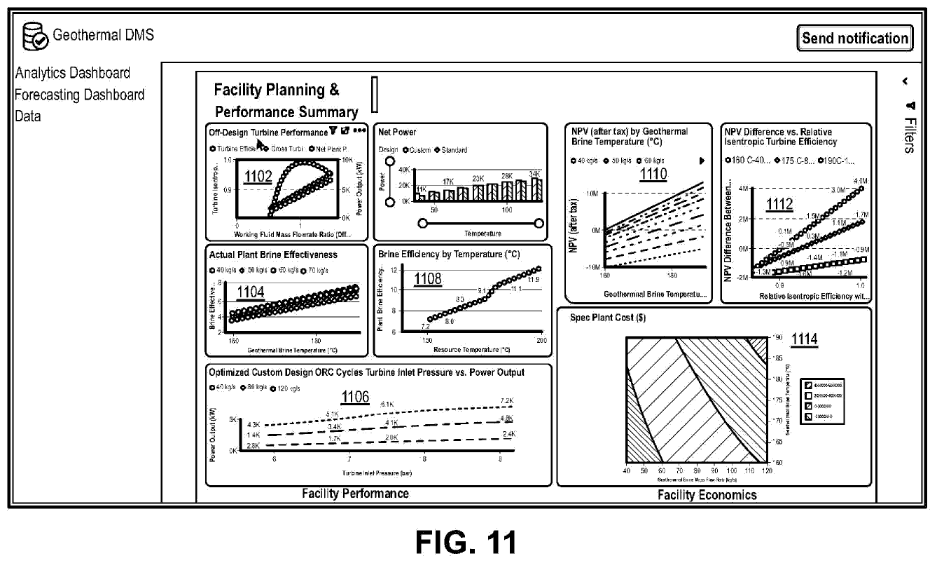

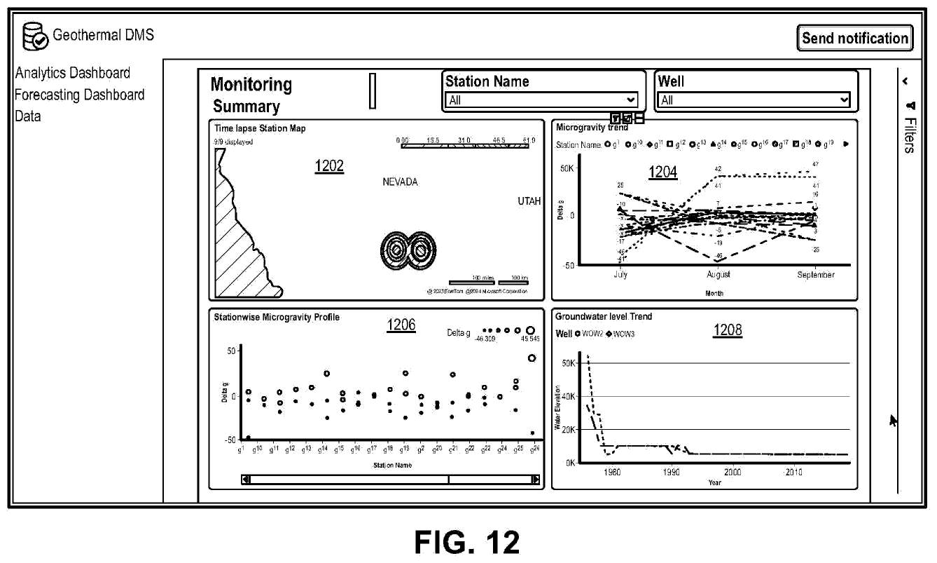

FIG. 5 is a flowchart of an example process that may be performed according to an embodiment to visualize processed data. In some embodiments, the visualization may initially provide an analytics dashboard that has sub-dashboards for each of a plurality of stages of a geothermal system. The analytics dashboards in some embodiments may include, but not be limited to: an appraisal summary, which is described below with reference to FIG. 6; an exploration summary, which is described below with reference to FIG. 7; a development summary, which is described below with reference to FIG. 8; a production performance summary, which is described below with reference to FIG. 9; an injector performance summary, which is described below with reference to FIG. 10; a facility planning and performance summary, which is described below with reference to FIG. 11; and a monitoring summary, which is described below with reference to FIG. 12.

The process shown in FIG. 5 may begin with a computing device parsing and extracting data from multiple types of files (step 502). The multiple types of files may include, but not be limited to, any of word processed files, image files, data files, spreadsheet files, and portable document files. The parsed and extracted data then may be processed (step 504) and ingested for each category of the data into a database (step 506). Parsing may search for data located in proximity to certain attribute names appearing in the data. Structured data may be extracted based on a specified data schema.

Each data item value may be checked against a corresponding valid range of values. If a data item value outside the corresponding valid range is detected, then an anomaly is detected (step 508), and a real-time alert may be provided to one or more predefined recipients (step 510). In some embodiments, the real-time alert may be provided via a push notification system. In other embodiments, an alert may be integrated with data ingestion pipelines as well as a push notification system. The real-time alert may be provided in a number of different ways including, but not limited to, an email, a text message, a flashing message on a display screen, and an audio message via a speaker. If anomalous data is detected during ingestion, then automated messages may be sent to the predefined recipients.

Machine learning techniques may be leveraged to obtain an optimum forecasting model (step 512). A number of different techniques may be used. In an embodiment, at least one of autoregressive integrated moving average (ARIMA) modelling and temporal fusion transformers (TFTs) may be used to obtain an optimum forecasting model including, but not limited to, a model for predicting, for example, sunspot activity or other activity or conditions. The optimum forecasting model may be used to provide a forecasting summary.

Next, the processed data may be visualized as specified (step 514). In various embodiments, the data may be visualized as specified in Power BI® (Power BI is a registered trademark of Microsoft Corp. of Redmond, Washington), Tibco Spotfire® (Spotfire is a registered trademark of Tibco Software Inc., a Delaware Corporation), Tableau™ (Tableau is a trademark of SALESFORCE Inc., a Delaware Corporation), or other similar software products.

Display screens may be displayed as dashboards with multiple smaller displays, or sub-dashboards, included therein. Selecting one of the multiple smaller displays on a display device with a pointing device, a user's finger on a touchscreen, or via other means may cause a larger version of the selected display to be presented on the display device. FIG. 6 shows an example of an analytics dashboard, which in this Figure is an appraisal summary display screen. In an embodiment, the appraisal summary display screen shows sub-dashboards that include: a chemical distribution of sodium, potassium, magnesium, and calcium; Saphir modelling parameters from injection test wells including permeability, porosity, thickness, and transmissibility; injection rate in liters per second for injection test wells; an analytical model of each injection test well; a comparison of a measured pressure trend with a simulated pressure trend; and an indication of well water quality. Selecting one of these sub-dashboards may cause a larger version of the sub-dashboard to be visualized.

FIG. 7 shows an example of an analytics dashboard, which in this Figure is an exploration summary display screen. This dashboard includes concise and summarized information about geothermal fields on a regional scale. The exploration summary display screen may display a lithology map 702 of a geothermal area, a surface manifestation found around a geothermal area 704, a magnetotelluric (MT) model 706 in 3D, a map view of an MT inversion model 708, a heat map of a gravity measurement 710, and a 3D MT profile 712.

FIG. 8 shows an example of an analytics dashboard, which in this Figure is a development summary display screen. This dashboard includes information regarding a fracture model of the area, pressure-temperature models, and different 3D models used in the development phase. The dashboard may include a deterministic lithology model 802, a fracture type stereo plot 804, a fracture model result 806, a temperature model of a geothermal system 808, coordinates and values of pressure MT 810, and coordinates and values of a temperature MT 812.

FIG. 9 shows an example of an analytics dashboard, which in this Figure is a production performance summary display screen. This dashboard may include insights regarding production trends in a field, field-wise details about production parameters, and an impact chart to show how production has changed over time. In an embodiment, the production performance summary may include year-wise water production 902 for each production well (in billions of gallons) and corresponding year-wise power in MWh 904, as well as well as yearly total power to sales 906. Temperature withdrawal from each well 908 also may be tracked so that a user can understand which wells have a temperature drop or may need maintenance. Total power produced 910 also may be displayed as well as a summary of well status 912.

FIG. 10 shows an example of an analytics dashboard, which in this Figure is an injector performance summary display screen. The injector performance summary display screen is similar to the production performance summary display of FIG. 9, but includes more information regarding an amount of water injected into formations 1002, a rate at which the water is injected 1004, and pressure-temperature conditions 1006. The injector performance summary display may display performance of each well over a period of time as a factor of a water injection rate, injection pressure, and temperature. A visualization of which formation is injected with more water than other formations also may be displayed in some embodiments.

FIG. 11 shows an example of an analytics dashboard, which in this Figure is a facility planning and performance summary display screen. This dashboard has two sections, facility performance and facility economics.

The facility performance section may provide details regarding how a power plant is performing in terms of turbine efficiency, net power output generated, and other parameters. Off-design turbine performance 1102 may be visualized, showing values including turbine isentropic efficiency ratio, working fluid mass ratio, and power output. Also, this section may display actual plant brine effectiveness 1104, optimized custom design ORC cycles turbine inlet pressure vs. power output 1106, and plant brine efficiency by temperature 1108.

The facility economics section may incorporate details about operational costs incurred by a facility during production from a geothermal system. According to embodiments, the facility economics section may display after tax net present value (NPV) by geothermal brine temperature 1110, NPV difference vs. relative isentropic turbine efficiency 1112, and spec plant cost 1114.

FIG. 12 shows an example of an analytics dashboard, which in this Figure is a monitoring summary display screen. This dashboard provides an overview regarding how a reservoir and a geothermal system change over time by leveraging trend plots and heat maps. The monitoring summary display screen may include a visualization of a time lapsed microgravity measurement 1202, a fluctuation of microgravity over time 1204, a stationwise microgravity profile 1206, and a groundwater level trend 1208.

A user may design display screens for use with various embodiments by specifying visualizations of data items using any of Power BI® (available from Microsoft Corporation of Redmond, WA), Tibco Spotfire® (available from TIBCO of Palo Alto, CA), Tableau™ (available from Tableau Software of Seattle, WA), or any other similar software product, and linking the visualizations to values of certain data items. Data items may include, but not be limited to, water injection rate, power production by year, actual plant brine effectiveness, brine efficiency by temperature, etc. Values of certain data items may be monitored periodically and visualized. The visualizations in some of the display screens may show trends as the monitored certain data items change over time. Further macros, which include instructions for displaying certain types of data objects, may be copied from one or more sources into various embodiments, thereby avoiding manual creation of the macros.

If any anomalous behavior is observed during analysis, a user may send a notification with details to concerned parties in real time. Some embodiments may include a push notification system that can be integrated with data ingestion pipelines. In such embodiments, if anomalous data is observed by a computing device during ingestion, automated mailers may be sent to the concerned parties.

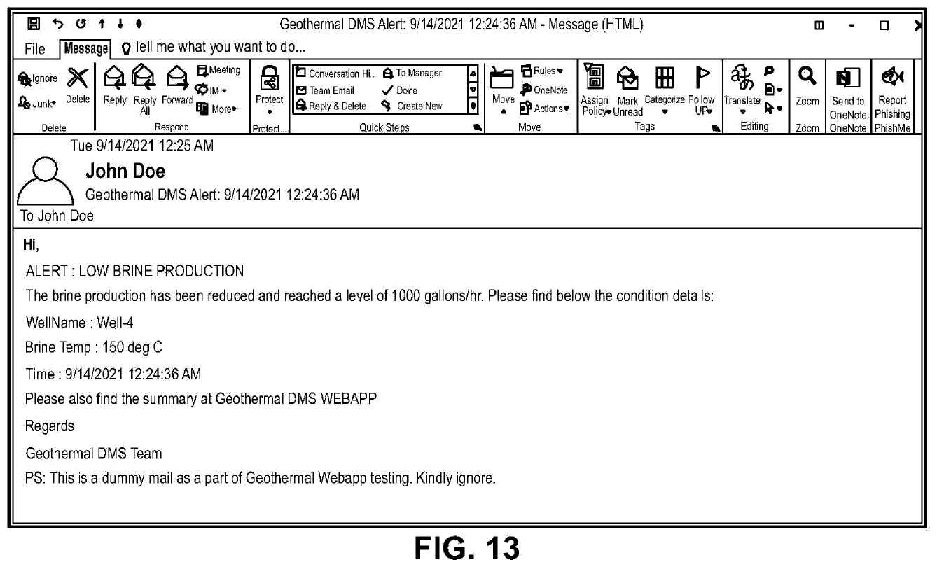

FIG. 13 illustrates an example email alert that may be generated upon detection of an anomaly according to an embodiment. In the example alert, a recipient of the email is informed that the brine production for Well-4 has been reduced and reached a level of 1,000 gallons per hour. Brine temperature and date and time also may be provided in the email. The alert was triggered, in this example, by detecting a drop in brine production below a specified brine production level.

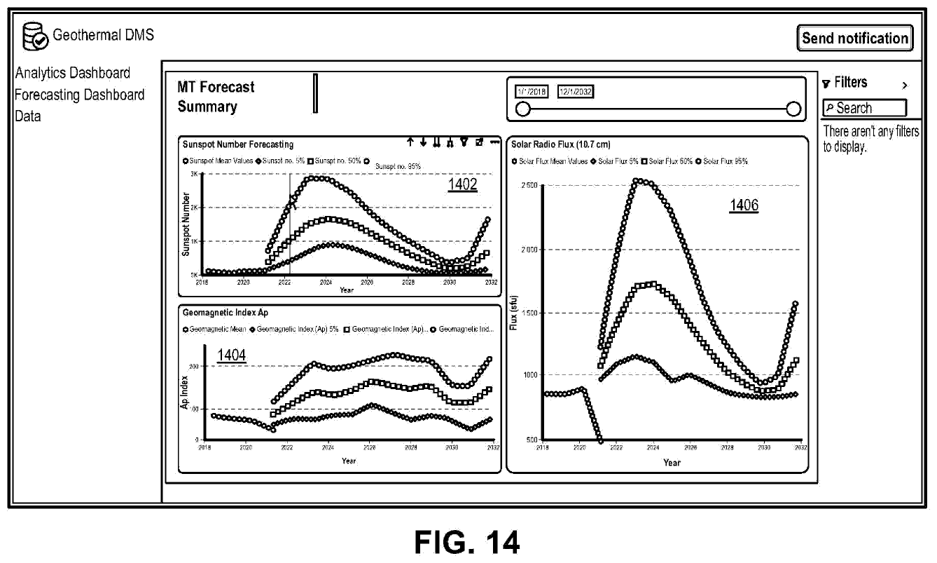

In some embodiments, a forecasting dashboard may be provided. For example, magnetotelluric (MT) data, which is used in geothermal system studies, is very dependent on sunspot activity and solar radio flux. A time during which there is minimum solar impedance while MT data is collected may be identified. As shown in FIG. 14, an MT forecast summary may include sunspot number forecasting 1402, geomagnetic index forecasting 1404, and solar radio flux forecasting 1406, which leverage machine learning to obtain an optimum forecasting model. In various embodiments, forecasting may be extended to include, but not be limited to, forecasting of production curves, groundwater trends, and pressure-temperature trends. Time series analysis, ARIMA modelling, and other statistical analysis may be included in some embodiments.

In embodiments, report generation had been made easier without expending a massive amount of time and labor. In various embodiments, reports may be generated automatically from the dashboards by selecting a single control or button of the dashboard.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

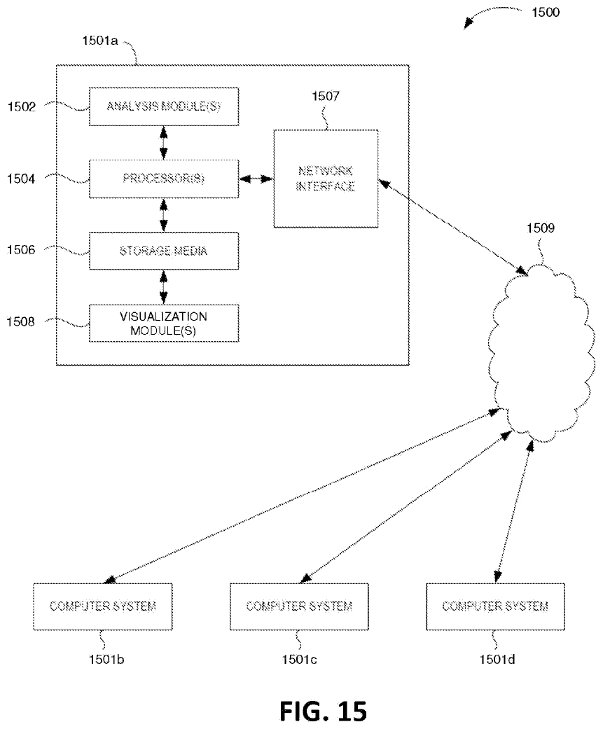

In some embodiments, any of the methods of the present disclosure may be executed using a system, such as a computing system. FIG. 15 illustrates an example of such a computing system 1500, in accordance with some embodiments. The computing system 1500 may include a computer or computer system 1501a, which may be an individual computer system 1501a or an arrangement of distributed computer systems. The computer system 1501a includes one or more analysis module(s) 1502 configured to perform various tasks according to some embodiments, such as one or more methods disclosed herein. To perform these various tasks, the analysis module 1502 executes independently, or in coordination with, one or more processors 1504, which is (or are) connected to one or more storage media 1506. The processor(s) 1504 is (or are) also connected to a network interface 1507 to allow the computer system 1501a to communicate over a data network 1509 with one or more additional computer systems and/or computing systems, such as 1501b, 1501c, and/or 1501d (note that computer systems 1501b, 1501c and/or 1501d may or may not share the same architecture as computer system 1501a, and may be located in different physical locations, e.g., computer systems 1501a and 1501b may be located in a processing facility, while in communication with one or more computer systems such as 1501c and/or 1501d that are located in one or more data centers, and/or located in varying countries on different continents).

A processor can include a microprocessor, microcontroller, processor module or subsystem, programmable integrated circuit, programmable gate array, or another control or computing device.

The storage media 1506 can be implemented as one or more computer-readable or machine-readable storage media. Note that while in the example embodiment of FIG. 15 storage media 1506 is depicted as within computer system 1501a, in some embodiments, storage media 806 may be distributed within and/or across multiple internal and/or external enclosures of computing system 1501a and/or additional computing systems. Storage media 1506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1500 contains one or more visualization module(s) 1508. In the example of computing system 1500, computer system 1501 a includes the visualization module 1508. In some embodiments, a single visualization module may be used to perform some or all aspects of one or more embodiments of the methods. In alternate embodiments, a plurality of visualization modules may be used to perform some or all aspects of methods.

It should be appreciated that computing system 1500 is only one example of a computing system, and that computing system 1500 may have more or fewer components than shown, may combine additional components not depicted in the example embodiment of FIG. 15, and/or computing system 1500 may have a different configuration or arrangement of the components depicted in FIG. 15. The various components shown in FIG. 15 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1500, FIG. 15), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for providing an integrated platform, the method comprising:
obtaining data from at least one source, the data being in a plurality of formats and related to one of an energy exploration stage, an energy development stage, and an operations stage;
specifying at least one data item from the at least one source for visualization;
processing the data, wherein the processing includes parsing, extracting, and ingesting the data, the data including the specified at least one data item;
leveraging machine learning to obtain an optimum forecasting model, the leveraging including using at least one of autoregressive integrated moving average modelling and temporal fusion transformers;
visualizing the specified at least one data item; and
providing a forecasting summary based on the optimum forecasting model.

2. The method of claim 1, wherein the one of the energy exploration stage, the energy development, and the operations stage are associated with geothermal energy.

3. The method of claim 2, wherein the visualizing initially provides an analytics dashboard having sub-dashboards for each of a plurality of stages of a lifecycle of a geothermal system.

4. The method of claim 1, wherein
the data is included in a plurality of different file types, the file types including at least two from a group consisting of image files, operational data files, spreadsheet files, word processing files, and portable document files.

5. The method of claim 1, further comprising: adding a macro to the integrated platform by copying the macro from a second source.

6. The method of claim 1, wherein the processing of the data further comprises:
determining whether the data includes an anomaly; and
providing a real-time alert when the data is determined to include the anomaly.

7. The method of claim 1, wherein:
the at least one source includes data from a different product such that the parsing and extracting and the visualizing produce a display screen substantially similar to a display screen produced by the different product.

8. A system for providing an integrated platform, the system comprising:
a processor;
a memory; and
a bus connecting the processor with the memory, wherein the memory includes instructions for the processor to perform operations comprising:
obtaining data from at least one source, the data being in a plurality of formats and related to one of an energy exploration stage, an energy development stage, and an operations stage;
specifying at least one data item from the at least one source for visualization;
processing the data, wherein the processing includes parsing, extracting, and ingesting the data, the data including the specified at least one data item;
leveraging machine learning to obtain an optimum forecasting model, the leveraging including using at least one of autoregressive integrated moving average modelling and temporal fusion transformers; and
visualizing the specified at least one data item such that a display screen is produced that is substantially similar to a display screen produced by a different product.

9. The system of claim 8, wherein the one of the energy exploration stage, the energy development, and the operations stage are associated with geothermal energy.

10. The system of claim 9, wherein the visualizing initially provides an analytics dashboard having sub-dashboards for each of a plurality of stages of a lifecycle of a geothermal system.

11. The system of claim 8, wherein:
the data is included in a plurality of different file types, the file types including at least two from a group consisting of image files, operational data files, spreadsheet files, word processing files, and portable document files.

12. The system of claim 8, wherein the operations further comprise:
adding a macro to the integrated platform by copying the macro from a second source.

13. The system of claim 8, wherein the visualizing further comprises:
providing a forecasting summary based on at least one of autoregressive integrated moving average modelling and temporal fusion transformers.

14. The system of claim 8, wherein the operations further comprise:
determining whether the data includes an anomaly; and
providing a real-time alert when the data is determined to include the anomaly.

15. The system of claim 8, wherein the machine learning includes at least one of autoregressive integrated moving average modelling and temporal fusion transformers.

16. A non-transitory computer-readable medium having instructions stored thereon for a processor of an integrated platform, such that when the processor executes the instructions, a plurality of operations are performed, the plurality of operations comprising:
obtaining data from at least one source, the data being in a plurality of formats and related to one of an energy exploration stage, an energy development stage, and an operations stage;
specifying at least one data item from the at least one source for visualization;
processing the data, wherein the processing includes parsing, extracting, and ingesting the data, the data including the specified at least one data item;
adding a macro to the integrated platform by copying the macro from a second source;
leveraging machine learning to obtain an optimum forecasting model, the leveraging including using at least one of autoregressive integrated moving average modelling and temporal fusion transformers;
visualizing the specified at least one data item, the visualizing providing an analytics dashboard having sub-dashboards for each of a plurality of stages of a lifecycle of a geothermal system;
determining whether the data includes an anomaly;
providing a real-time alert when the data is determined to include the anomaly; and
providing a forecasting summary based on the optimum forecasting model, wherein:
the visualizing produces a display screen that is substantially similar to a display screen produced by a different product.

17. The non-transitory computer-readable medium of claim 16, wherein the operations further comprise performing a wellsite action in response to the real-time alert or the forecasting summary.

18. The non-transitory computer-readable medium of claim 17, wherein the wellsite action comprises a physical action at a wellsite.

19. The non-transitory computer-readable medium of claim 17, wherein the wellsite action comprises generating and transmitting a signal that causes a physical action to occur at a wellsite.

20. The non-transitory computer-readable medium of claim 17, wherein the wellsite action comprises, in a geothermal system, drilling a well, varying a weight and/or torque on a drill bit that is drilling the well, varying a drilling trajectory of the well, or varying a concentration and/or flow rate of a fluid pumped into the well.
